(19) United States
(12) Patent Application Publication
(10) Pub. No.: US 2024/0011614 A1
(43) Pub. Date: Jan. 11, 2024

(54) DEPARTURE LIGHTING

(71) Applicant: Rivian IP Holdings, LLC, Plymouth, MI (US)

(72) Inventors: Austin FREDERICKSON, Carlsbad, CA (US); Joshua BAYER, Costa Mesa, CA (US); Christian V. ELDER, Irvine, CA (US); Paula Michelle LOBACCARO, San Clemente, CA (US); Zechariah John RUDNICKI, Holt, MI (US); Lily MACARUSO, Woodland Park, CO (US)

(21) Appl. No.: 17/943,002

(22) Filed: Sep. 12, 2022

Related U.S. Application Data
(60) Provisional application No. 63/359,757, filed on Jul. 8, 2022.

(51) Int. Cl. F21S 41/663

(52) U.S. Cl. CPC F21S 41/663

(57) ABSTRACT

Particular embodiments may provide an apparatus that includes a departure light source, a crossbar with a light source, and a controller. In some further embodiments, the controller is configured to: determine an orientation of a vehicle; and in response to determining the orientation, cause the departure light source to generate a light.

### CROSS-REFERENCE TO RELATED APPLICATIONS

This application claims the benefit of U.S. Provisional Application No. 63/359,757, filed Jul. 8, 2022, the entirety of which is incorporated by reference herein.

### INTRODUCTION

Vehicle headlamps illuminate regions in front of vehicles, illuminating obstacles in reduced-visibility situations (e.g., night-time). In some vehicles, additional lamps supplement the vehicle headlamps; these additional lamps can be, for instance, spotlights mounted to the roof of a truck. Such additional lamps may improve the safety function of the vehicle headlamps.

### BRIEF SUMMARY

Disclosed herein are departure light sources that supplement non-vehicle regions illuminated by vehicle headlamps. The departure light sources illuminate regions further from the vehicle than the vehicle headlamps and may be particularly advantageous when a vehicle departs an incline, for example an off-road vehicle driving down a hill or gully. In some embodiments, the departure light sources receive signals from a controller, where the controller determines a vehicle orientation and, in response to that determination, causes the departure light sources to generate a light. In this way, the controller and departure light sources work together to illuminate obstacles that might otherwise escape illumination when relying on vehicle headlamps.

In some embodiments, an apparatus includes a departure light source, a crossbar with a light source, and a controller. In some further embodiments, the controller is configured to: determine an orientation of a vehicle; and in response to determining the orientation, cause the departure light source to generate a light.

The controller is, in some embodiments of the apparatus, further configured to: in response to determining the orientation, cause the crossbar light source to generate a light.

In some embodiments of the apparatus, the crossbar light source generates light with a first center beam and the departure light source generates light with a second center beam, where the first center beam and the second center beam subtend an angle. The departure light source generates, in some embodiments, light with a center beam that subtends an angle with a mounting plane of the crossbar.

In some embodiments of the apparatus, the controller is configured to determine an orientation by: determining the vehicle is travelling down an incline; and determining the vehicle is approaching an end of the incline.

In some embodiments of the apparatus, the controller is configured to: in response to determining the orientation, determine whether the vehicle meets an orientation lighting criteria; in response to determining the vehicle meets the orientation lighting criteria, permit causing the departure light source to generate the light; and in response to determining the vehicle does not meet the orientation lighting criteria, prevent the departure light source generating the light.

The controller is, in some embodiments, configured to: determine the orientation has ended; and in response to determining the orientation has ended, cause the departure light source to stop generating the light. In some embodiments, the controller is configured to: determine a sequence of a vehicle; and in response to determining the sequence, cause the crossbar light source to generate a light. The controller is, in some embodiments, configured to: in response to determining the sequence, cause the departure light source to generate a light in coordination with the crossbar light source generating a light.

In some embodiments of the apparatus, the departure light source includes an electrical connection. The departure light source includes, in some embodiments, a mount for coupling the departure light source to the crossbar. The apparatus includes, in some embodiments a mount for coupling the departure light source to the crossbar and an electrical connection, where the mount includes the electrical connection. In some embodiments, the departure light source is integrated with the crossbar.

In some embodiments, a vehicle includes: a headlamp light source that illuminates a first region in front of the vehicle; a departure light source that illuminates a second region in front of the vehicle, where the first region is closer to the vehicle than the second region; and a control system. In some further embodiments, the control system includes a processor and a memory with instructions executable by the processor, the processor operable to execute the instructions to perform operations. In some embodiments, the operations include: determine an orientation of the vehicle; and in response to determining the orientation, cause the departure light source to illuminate the second region.

In some embodiments, the headlamp light source generates light with a first center beam and the departure light source generates light with a second center beam, where the first center beam and the second center beam subtend an angle. The vehicle includes, in some embodiments, a crossbar with a light source that illuminates a third region in front of the vehicle, where the third region is positioned between the first and second regions.

In some embodiments of the vehicle, the processor is operable to execute the instructions to perform operations further including: determine the orientation has ended; and in response to determining the orientation has ended, cause the departure light source to stop illuminating the second region.

In some embodiments, a computer-readable non-transitory storage media embodying software includes instructions operable when executed to perform operations. In some embodiments, the instructions include: determining an orientation of a vehicle; and in response to determining the orientation, cause a departure light source to generate a light.

In some embodiments, the instructions are operable when executed to perform operations further including: in response to determining the orientation, determine whether the vehicle meets an orientation lighting criteria; in response to determining the vehicle meets the orientation lighting criteria, permit causing the departure light source to generate the light; and in response to determining the vehicle does not meet the orientation lighting criteria, prevent the departure light source generating the light.

In some embodiments, the instructions are operable when executed to perform operations further including: determine the orientation has ended; and in response to determining the orientation has ended, cause the departure light source to stop generating the light.

In some embodiments of the computer readable medium, the instructions are operable when executed to perform operations further including: determine a sequence of the vehicle; and in response to determining the sequence, coordinate causing the departure light source generating a light and the crossbar light source generating a light.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, an apparatus, and a computer program product, wherein any feature mentioned in one claim category, e.g., method, can be claimed in another claim category, e.g., apparatus, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example truck with a departure light source.

FIG. 2 illustrates an example sports utility vehicle (SUV) with a departure light source.

FIG. 3 illustrates a departure light source illuminating a region in front of a vehicle.

FIG. 4 is a flowchart illustrating steps of a method for causing a departure light source to generate a light.

FIG. 5 is a flowchart illustrating steps of a method for causing a departure light source to generate a light in response to determining a vehicle meets an orientation lighting criteria.

FIG. 6 is a flowchart illustrating steps of a method for causing a departure light source to generate a light.

FIG. 7 illustrates an example vehicle.

FIG. 8A is a schematic of an example computer system.

FIG. 8B illustrates example firmware for a vehicle electronic control unit (ECU).

### DETAILED DESCRIPTION

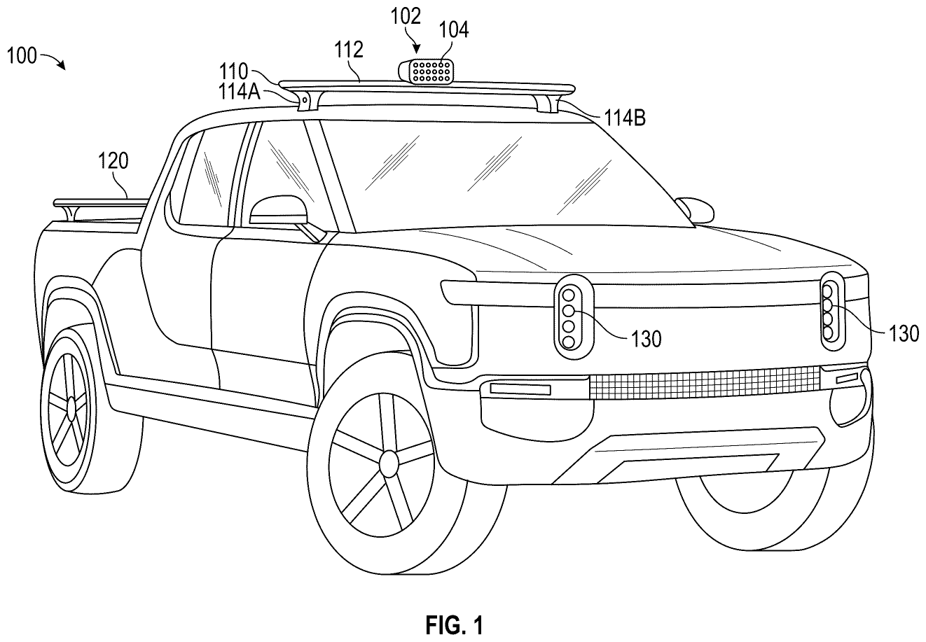

FIG. 1 illustrates an example truck 100 with crossbars 110 and 120 and headlamps 130. Crossbar 110 is mounted on a roof of truck 100 via mounts 114A and 114B and crossbar 120 is mounted on a truck-bed side-panel of truck 100. Departure light source 102 is coupled to crossbar 110. Although FIG. 1 and this disclosure primarily discusses a departure light source used in conjunction with a crossbar, it should be appreciated that departure light source embodiments described herein could be separate from a crossbar. In such embodiments, the disclosure light source may include a connection for coupling to an accessory port on the vehicle. Further, although certain figures herein (e.g., FIG. 1) illustrate the departure light source as a component separate from the crossbar, the departure light source could be incorporated into a crossbar. Such embodiments may include dedicated LEDs and lensing for the departure light source functions described herein.

Truck 100 may be configured so that departure light sources are, for example, activated in response to determining an orientation of truck 100. For example, when truck 100 departs an incline, headlamps 130 may not provide sufficient illumination for the truck 100 to safely navigate upcoming terrain. Headlamps 130 generate light in a direction generally parallel to the vehicle's horizontal plane, but pointing at a slightly downward angle so as to illuminate the path in front of the vehicle out to a desired throw distance. However, when truck 100 is driving down an incline (e.g., going down a hill or into a gully), since the direction of headlamps 130 is parallel to the angled terrain and thus at an angle to upcoming terrain that is less inclined (e.g., level terrain), the throw distance of headlamps 130 may be considerably shortened and unable to provide illumination for a sufficient distance down the terrain ahead of the vehicle. Similarly, although the headlamps 130 may provide sufficient illumination of upcoming obstacles in front of truck 100 while the vehicle travels on level terrain or no incline, when truck 100 approaches a change in grade (for example, when transitioning from an incline to level terrain), headlamps 130 provide limited illumination of obstacles positioned after the grade transition. Obstacles positioned immediately after the transition may be illuminated, but obstacles further from the transition may not. Crossbar light source 112 may supplement the headlamps 130, but the crossbar light source may also fail to sufficiently illuminate upcoming obstacles after the incline departure. Advantageously, truck 100 includes departure light source 102 which illuminates a non-vehicle region beyond those regions illuminated by the vehicle's headlamps and, if applicable crossbar light sources.

As used herein, determining an orientation of a vehicle includes determining the vehicle is approaching a change in grade (e.g., the vehicle is travelling on a decline and approaches level ground, the vehicle is travelling on level ground and approaches an incline), the vehicle is elevating, the vehicle is heaving, the vehicle is strafing, the vehicle is swaying, the vehicle is walking, the vehicle is surging, the vehicle is yawing, the vehicle is pitching, and/or the vehicle is rolling. As used herein, a chance in grade may be understood to include at least a +/−5 degree change in terrain. Although the departure light source in FIG. 1 (and elsewhere described herein) primarily focus on departure lighting from an incline, it should be appreciated that the scope of this disclosure also covers departure lighting for other vehicle orientations. All embodiments disclosed herein are equally applicable to other vehicle orientation. For example, if truck 100 were travelling on level ground and approaching an incline, the departure light sources described herein may advantageously illuminate additional regions further up the incline. In some embodiments, different combinations of sensors, signals, and light sources may be utilized for departing onto an incline. For example, for a determination of vehicle heave, additional lighting may illuminate areas surrounding the vehicle. In such embodiments, a vehicle may include a crossbar with lighting positioned at the end of the crossbar, such as on the peripheral edge of the crossbar or on a bottom surface (e.g., the surface facing the roof of the vehicle), and illuminating the sides of the vehicle. Such lighting may also provide additional illumination in response to determination of a sway, a pitch, a roll, or a yaw of the vehicle.

In the embodiment of truck 100, departure light source 102 includes a plurality of light sources 104. Such light sources could include, for example, LEDs projecting light at an angle upward from the crossbar's mounting plane and/or upward from the vehicle's horizontal plane. In this way, the light sources provide illumination beyond the regions illuminated by headlamps 130 and crossbar light source 112. Thus, departure light source 102 aids a driver of truck 100 in identifying obstacles positioned after a change in grade from an incline, for example. It will be understood that the plurality of light sources 104 in departure light source 102 is exemplary. Other embodiments include a single light source, such as an incandescent bulb. As used here, “a light source” is understood to encompass embodiments with a single light source and embodiments with a plurality of light sources. For example, “crossbar light source 112” encompasses crossbar embodiments with a single light source and crossbar embodiments with a plurality of light sources. In some embodiments, the departure light source's angle is adjustable. For example, the departure light source may be automatically adjustable based on the amount of terrain change. In some such embodiments, a servo motor may be utilized to control the angle of the departure light source. In some embodiments, the departure light source is adjustable so that it can be rotated and illuminate regions to the sides of the vehicle. Such rotatable departure light sources may provide additional illumination in response to determination of a sway, a pitch, a roll, and/or a yaw of the vehicle.

In some embodiments, a controller is configured to transmit a signal to a departure light source. Such a signal may cause the departure light source to perform an action. Such an action may include, for example, generating a wide-beam bright-white light to illuminate upcoming obstacles. The controller may also be configured to transmit a signal to the departure light source in response to determining a condition is met. For example, the controller is configured, in some embodiments, to determine a vehicle orientation and, in response to determining the vehicle departure, transmit a signal to the departure light source. In some embodiments, the signal causes the departure light source to perform an action (for example, activate, de-active, generate light, stop generating light). During normal operation, the departure light source 102 does not, in some embodiments, perform an action. However, when the controller identifies the vehicle is departing an incline, the departure light source may be illuminated.

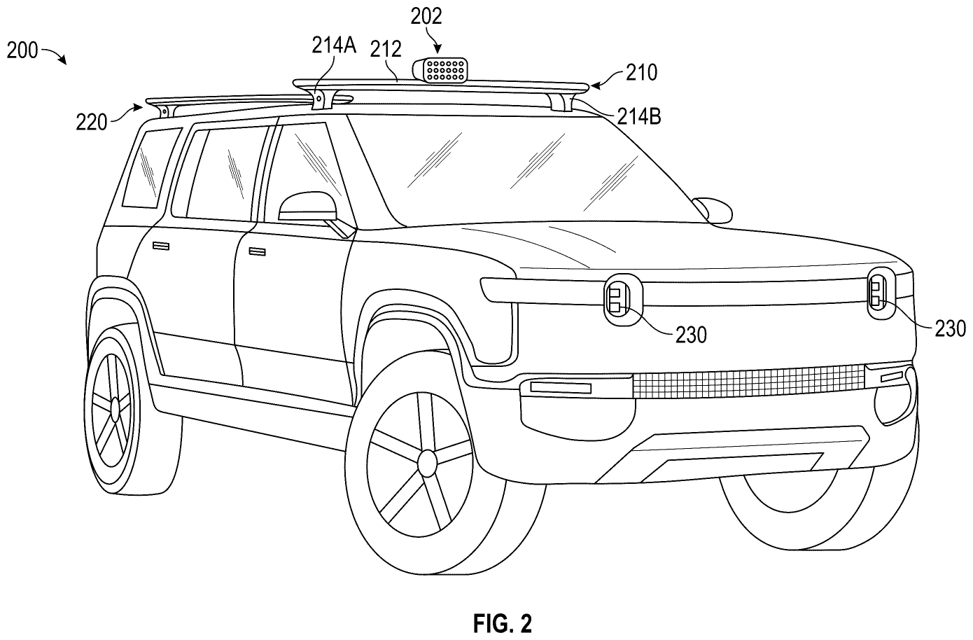

FIG. 2 illustrates an example SUV with crossbars 210 and 220 and headlamps 230. SUV 200 includes a departure light source 202 (similar to departure light source 102 in FIG. 1) mounted to crossbar 210. Also similar to FIG. 1, crossbar 210 includes a light source 212 and mounts 214A and 214B. Crossbars 210 and 220 are mounted to roof of SUV 200 and departure light source 202 is mounted to crossbar 210.

The vehicles in FIGS. 1 and 2 are exemplary. Although this disclosure illustrates departure light sources on a truck and an SUV, it should be appreciated that the departure light sources described herein are not limited by the type of vehicle on which the departure light source is mounted. For example, departure light sources could be mounted to passenger vehicles, delivery vehicles, tractors, camping vans, etc. Further, unless expressly described, departure light sources herein are not limited by the position on which they are mounted to a vehicle. For example, although FIGS. 1 and 2 illustrate the departure light sources mounted to crossbars (in turn mounted to the roof) a vehicle, departure light sources could be mounted in the interior of a vehicle, mounted on the outer surface of a windshield or other glass, mounted to the top of a driver's side doorframe, mounted to the vehicle's hood, etc.

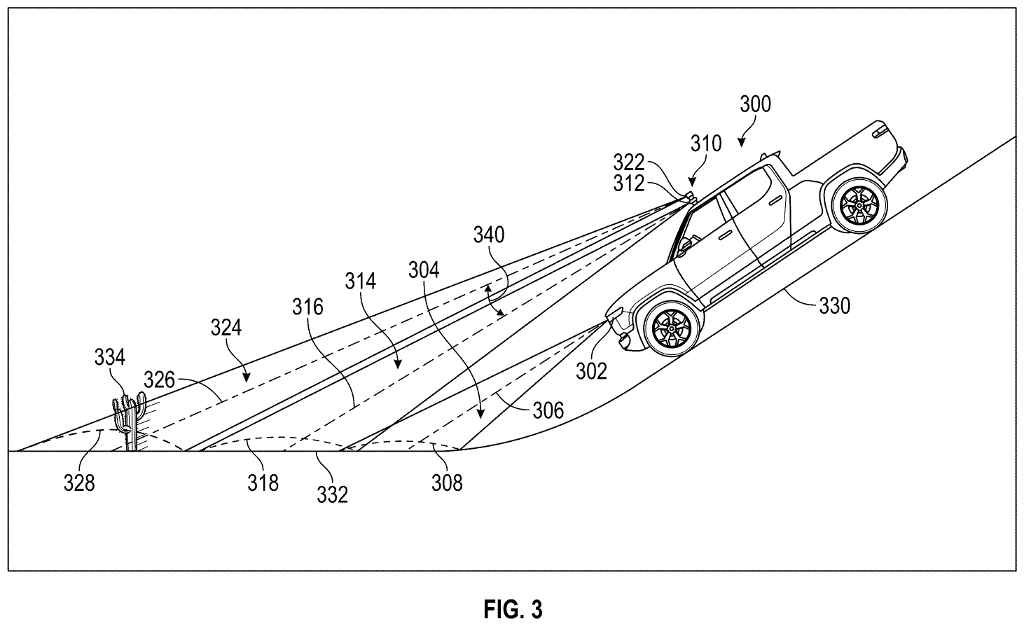

FIG. 3 illustrates vehicle 300 travelling down incline 330 and approaching a change in grade to level terrain 332. Vehicle 300 includes headlamp light source 302, crossbar 310 with crossbar light source 312, and departure light source 322. Level terrain 332 includes obstacle 334.

Headlamp light source 302 projects beam 304. Beam 304 spreads out from headlamp light source 302 to create a cone of light which illuminates region 308 in front of vehicle 300. Beam 304's light cone includes center beam 306. As used herein, a center beam may be understood to include the mid-line of a beam. For example, beam 304 expands out from light source 302 to create a cone; center beam 306 is the central axis of that cone of light.

Crossbar light source 312 projects beam 314, which includes center beam 316, to illuminate region 318 in front of vehicle 300. As a result of light source 312's higher position on the vehicle than headlamp light source 302, region 318 is further from vehicle 300 than region 308. Although center beam 316 is shown parallel to center beam 306, it should be understood that this is exemplary. In other embodiments, center beam 316 and center beam 306 subtend an angle.

Departure light source 322 projects beam 324, which includes center beam 326, to illuminate region 328 in front of vehicle 300. As a result of light source 322's subtended angle 340 with crossbar light source 312, region 328 is further from vehicle 300 than region 318 (and consequently region 308).

Due to vehicle 300 departing incline 330, neither illumination region 308 nor illumination region 318 encompasses obstacle 334. Although obstacle 334 may be no more than a few meters in front of vehicle 300, beam 304 of headlamp light source 302 does not illuminate the obstacle nor does beam 314 of crossbar light source 312. Thus, traditional vehicle headlamps 302 present a risk that a driver of vehicle 300 will have insufficient time to execute an evasive maneuver or, even with sufficient time to avoid obstacle 334, execute a hasty maneuver that threatens the safety of vehicle 300 and its occupants. In contrast, beam 324 of departure light source 322 illuminates region 328 and illuminates obstacle 334. Region 328 is further in front of vehicle 300 than region 318 and region 308, advantageously improving driver visibility. Although region 328 is illustrated as having no overlap with either region 318 and 308, other embodiments may have overlap. For example, region 328 overlaps region 318 in some embodiments. In some embodiments, region 328 overlaps region 318 and region 308.

In some embodiments, center beam 326 of departure light source 322 subtends angle 340 with center beam 316. As used herein, two lines (or a line and a plane, or two planes) subtend an angle when the intersection of the lines (or line and plane, or two planes) have a non-zero angle at their intersection; where two lines do not intersect (for example, center beams 316 and 326), the lines are extended to a point of intersection to determine the angle. In some embodiments, center beam 326 of departure light source 322 subtends an angle with a mounting plane of the crossbar. As used herein, a mounting plane of a crossbar includes a plane that includes the crossbar's mounts at their point of coupling to a vehicle. In some embodiments, a crossbar is mounted to a roof of a vehicle and the crossbar's mounting plane comprises a plane of the roof. In some embodiments, center beam 326 of departure light source 322 subtends an angle with center beam 306 of the headlamp light source 302.

In some embodiments, the departure light source comprises an electrical connection that is coupled to the light source. The electrical connection may receive power, data, and control signals from the vehicle; data transmission and control signals may be used to operate the departure light sources. In some embodiments, an electrical connection is integral with a mount that physically connects the departure light source to a vehicle, a crossbar, or other accessories. In some embodiments, the electrical connection is not physically connected to the vehicle or an accessory. For example, power may be provided to a departure light source through a battery source (e.g., a battery compartment in the crossbar) and data transmission/ control is via a wireless connection (for example, Bluetooth, Wi-Fi, NEC, etc.).

In vehicle 300, the departure light source 322 is mounted to crossbar 310. In other embodiments, the departure light source is mounted to directly to the vehicle without a crossbar. Such connections could be in the cab, or on top of the vehicle, or attached to the outer surface of the windshield, or attached to the top of a driver's side doorframe. In some embodiments where the departure light source couples to a crossbar, the crossbar comprises an accessory insertion port for receiving the departure light source.

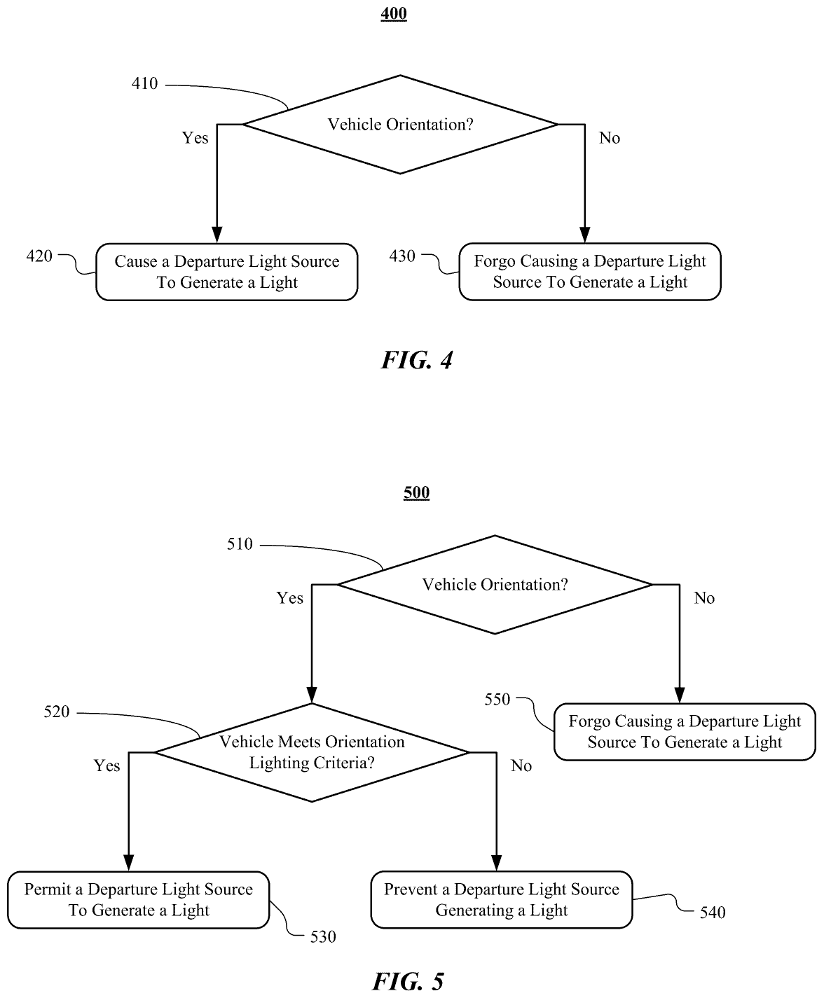

In some embodiments, a controller is configured to determine an orientation of a vehicle and, in response to determining the orientation, cause the departure light source to generate a light. In some embodiments, a controller is configured to determine an orientation of a vehicle and, in response to determining the orientation, transmit a signal. In some embodiments, the signal may cause the departure light source to perform an action (e.g., activate, de-activate). FIG. 4 is a flowchart illustrating steps of a method 400 for causing a departure light source to generate a light. Method 400 may begin with decision point 410, the controller determining the vehicle is in an orientation. If [yes], method 400 may then continue at step 420 with causing the departure light source to generate a light. Otherwise, if [no], then at step 430, method 400 forgoes causing a departure light source to generate a light.

In some embodiments, method 400 is performed by a controller in one or more of vehicle 100, vehicle 200, and vehicle 300. Using vehicle 300 and FIG. 3 as an illustrative example, vehicle 300 is travelling down incline 330 as it approaches level terrain 332. Before approaching level terrain 332, performance of method 400 results in [no] at step 410 and forgoing (step 430) causing a departure light source to generate a light. As vehicle 300 approaches level terrain 332, the controller performing step 410 results in a [yes] determination, i.e., determining an orientation of vehicle 300, and the controller then causes, i.e., step 420 of method 400, the signal to the departure light source 322. The signal may cause departure light source 322 to perform an action. In the embodiment illustrated in FIG. 3, the action is generation of light beam 324 (e.g., a white light beam) that illuminates a region 328 that is further from the vehicle 300 than other illuminated regions 308 and 318. Advantageously, illuminating region 328 may capture additional objects (e.g., cactus 334) that would not be illuminated by other lights on vehicle 300.

A controller is configured, in some embodiments, to transmit a signal to the departure light source. In some embodiments, the same controller or a different controller is also configured to transmit a signal to the crossbar light source (if applicable). The signal may cause the light source to perform an action, e.g., generation of light (e.g., step 420 of method 400). As used herein, a light source may be understood to perform an action when it changes state in response to a signal. By way of illustration, an action may include generating light (e.g., white light, red light, yellow light, blue light, green light, etc.), stopping light generation (e.g., switching off a light source that was generating light before the action), and changing a light color (e.g., switching an activated white light to a red light, switching an activated yellow light to a white light). Light generation includes, for example, continuous illumination and periodic illumination (such as flashing, blinking, or pulsing), light of a single color, changing color, or combined colors, and light of constant or varying intensity.

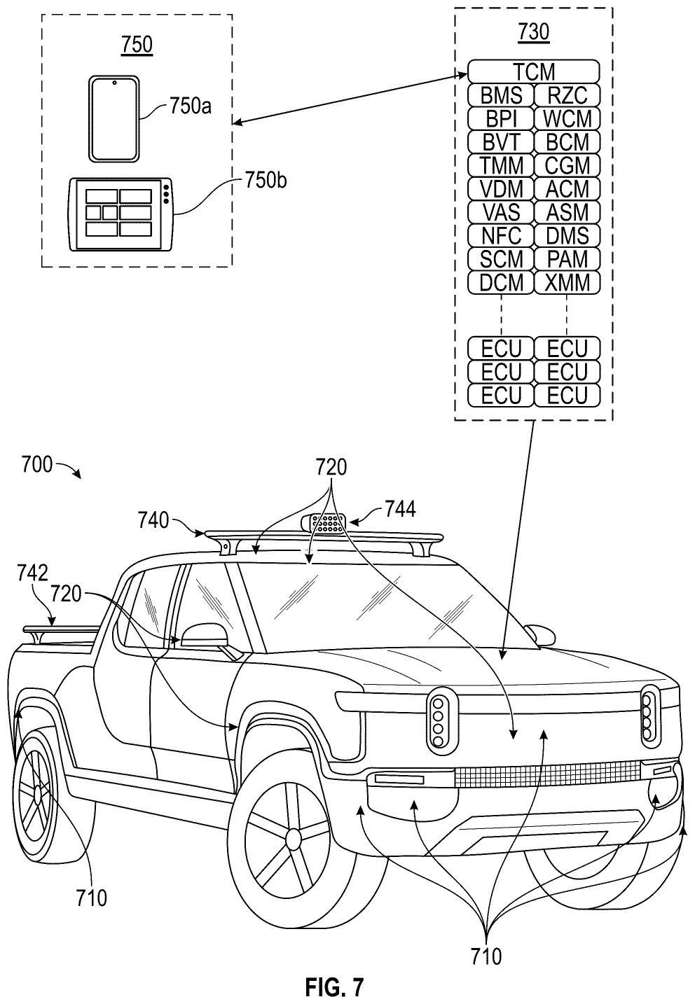

A controller may directly or indirectly “cause” a light source to perform an action, such as generating a light. For example, a controller may be associated with a departure light source (for example, installed in the departure light source or added to the vehicle), may be associated with the vehicle (e.g., installed in the vehicle for non-orientation and/or departure light functions and modified to also perform orientation and/or departure light functions) (exemplary vehicle controllers are disclosed below with respect to FIG. 7), and may be associated with an accessory (e.g., installed in a crossbar). In some embodiments, a controller that determines the orientation of the vehicle may send a signal to another controller (e.g., one that directly communicates with the departure light source) to transmit the signal to the light source that causes the light source to, e.g., generate light. In some embodiments, the controller that transmits the signal to another controller that then causes the light source to take an action (in this example, light generation). In such instances, multiple controllers work together to form a single controller that determines the orientation and, in response to determining the orientation, transmit a signal to a light source (to cause light generation, for example).

A controller may determine an orientation, e.g., as illustrated in step 410 of method 400. In some embodiments, determining an orientation includes determining an incline departure, which may include determining that a vehicle is travelling down an incline and also approaching an end of the incline. In some embodiments, a controller (e.g., a Vehicle Dynamics Module (VDM) ECU, a Telematics Control Module (TCM) ECU, a Central Gateway Module (CGM) ECU) determines that the vehicle is travelling down an incline by receiving signals from vehicle sensors, such as gyroscopes, positioning systems (e.g., GPS, Wi-Fi, Bluetooth, Cellular, communication with other vehicles, etc.), altimeters, etc. In some embodiments, determining the vehicle is approaching an end of incline includes receiving signals from vehicle sensors, such as proximity detectors (radar, LIDAR, NEC, etc.), positioning systems (e.g., GPS, Wi-Fi, Bluetooth, Cellular, communication with other vehicles, etc.), and image recognition systems. In some embodiments, determining an orientation includes accessing a database of orientation positions (e.g., incline departure positions) and correlating with the position of the vehicle (e.g., using positioning systems). In some embodiments, the controller accesses a database of known visibility-limited locations and, combined with positioning systems, causes the departure light source to perform an action in response to determining the vehicle is travelling into a visibility-limited location. In some embodiments, determining an orientation includes analyzing a set of parameters including, for example, vehicle angle, vehicle speed, or ultrasonic data. Other vehicle systems could be used in determining when to transmit a signal to a departure light source. For example, a controller (e.g., a Body Control Module (BCM) ECU) may determine that vehicle headlamps are not switched on, thereby indicating that departure light sources are not needed at that time. Similarly, an ambient light monitor may determine that there is sufficient ambient light that a departure light source is not needed at that time.

The controller may be configured to cause, in response to determining an orientation, a crossbar light source to generate light. For example, a controller may assess the severity of a grade change and forgo transmitting a signal to a departure light source (e.g., a signal that causes the departure light source to perform an action, such as generating a light) and instead send a signal to a crossbar light source (e.g., a signal that causes the crossbar light source to generate a light that illuminates a region in front of the vehicle).

Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for transmitting a signal to a departure light source (e.g., to perform an action such as generating light) including the particular steps of the method of FIG. 4, this disclosure contemplates any suitable method for transmitting a signal to a departure light source to including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

In some embodiments, a controller is configured to restrict actions by a mode or state of the vehicle. For example, a user may be restricted from activating the departure light source from a user interface unless the vehicle is a parked mode; a controller (e.g., an Experience Management Module (XMM) ECU) first determines whether the vehicle is in a parked mode before permitting activation of a departure light source. In other embodiments, the departure light source may be activated from the user interface in off-road mode. In yet other embodiments, there is no restriction on activating the departure light sources via a user interface. As another example, a departure light source may be restricted to off-mode uses only. In such embodiments, a controller (e.g., a CGM ECU) may first determine that the vehicle is off-road before transmitting the signal to the departure light source (e.g., causing the departure light source to generate a light).

FIG. 5 is a flowchart illustrating steps of a method 500 for causing a departure light source to generate a light source in response to determining a vehicle meets a vehicle orientation lighting criteria. Method 500 may begin with decision point 510, the controller determining the vehicle is in an orientation. If [yes], method 500 may then continue at decision 520. Otherwise, if [no], then at step 550, method 500 forgoes causing a departure light source to generate a light. At decision point 520, the controller determines whether the vehicle meets an orientation lighting criteria. If [yes], method 500 may then continue at step 530 with causing a departure light source to generate a light. Otherwise, if [no], then at step 540, method 500 prevents causing a departure light source to generate a light.

In some embodiments, the orientation light criteria is that the vehicle is off-road. In such embodiments, a controller determines whether the vehicle is off-road. If [yes] (e.g., vehicle 300 is in a desert landscape), the controller causes a departure light source (e.g., light source 322) to generate light when the controller determines an orientation of the vehicle. If [no] (e.g., vehicle is driving on a city street), the controller prevents the departure light source generating a light, even when a controller determines an orientation of the vehicle.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for causing a departure light source to generate light in response to determining a vehicle meets an orientation lighting criteria including the particular steps of the method of FIG. 5, this disclosure contemplates any suitable method for causing a departure light source to generate light in response to determining a vehicle meets an orientation lighting criteria including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

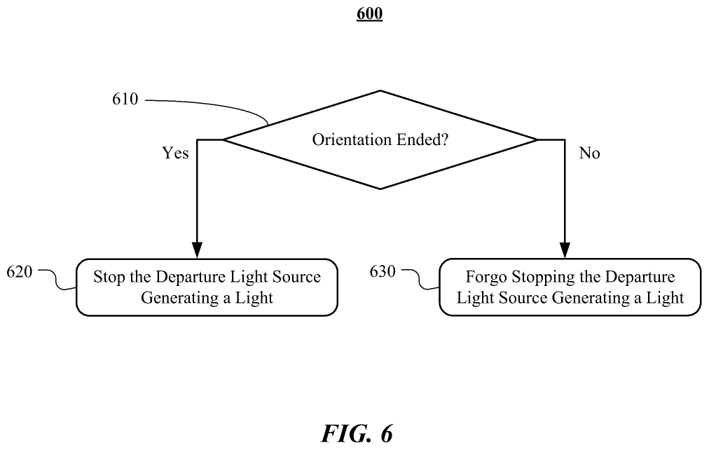

In some embodiments, a controller (e.g., a VDM ECU, a TCM ECU, a CGM ECU) is further configured to determine an orientation has ended. In response to determining the orientation has ended, the controller transmits a signal to the departure light source (e.g., to cause the departure light source to stop generating a light). FIG. 6 is a flowchart illustrating steps of a method 600 for stopping a departure light source generating a light. Method 600 may begin with decision point 610, the controller determining whether the vehicle has ended the orientation. If [yes], method 600 may then continue at step 620 with stopping the departure light source generating a light. Otherwise, if [no], then at step 630, method 600 forgoes stopping the light source generating a light.

Using FIG. 3 and vehicle 300 as an illustrate example, once vehicle 300 is on level terrain 332, departure light sources are no longer needed. Thus, method 600 advantageously determines that departure source 322 should be switched off when vehicle 300 has left incline 330 and/or is driving on level terrain 332. Method 600 may continuously operate once an orientation is determined and the departure light source is generating light. In other embodiments, method 600 may be performed periodically or when a change in state has been detected (e.g., a gyroscope signal indicates that vehicle 300 is level).

In some embodiments, a controller determines an orientation has ended by receiving signals from vehicle sensors, such as gyroscopes, positioning systems (e.g., GPS, Wi-Fi, Bluetooth, Cellular, communication with other vehicles, etc.), altimeters, proximity detectors (radar, LIDAR, NEC, etc.), and image recognition systems, and/or by accessing a database of orientation positions (e.g., incline departure positions) and correlating with the position of the vehicle (e.g., using positioning systems).

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for stopping a departure light source generating a light including the particular steps of the method of FIG. 6, this disclosure contemplates any suitable method for stopping a departure light source generating light, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

In some embodiments, a controller is configured to determine a vehicle sequence and, in response to determining the vehicle sequence, cause a crossbar light source and/or a departure light source to generate a light. In some embodiments, a controller is configured to, in response to determining the sequence, cause the departure light source to generate light and cause the crossbar light source to generate light. As used herein, a vehicle sequence may be understood to correspond to a step or steps in a vehicle process. A vehicle sequence is, in some embodiments, initiated by a user activated instruction, for example a user pressing on a brake pedal, a user activating a turn signal, a user locking/unlocking a vehicle with a remote key, and a user interacting with a user interface. A vehicle sequence may, in some embodiments, be independent of the crossbar or departure lamp. For example, a vehicle ECU determines a sequence for vehicle braking (for example, a regenerative braking system) and does so whether the vehicle has an associated crossbar; when a crossbar disclosed herein is added to vehicle, a controller determines (by monitoring the corresponding ECU and/or by receiving a signal from the ECU) the vehicle braking sequence and, in response to determining the vehicle braking sequence, transmit a signal to a crossbar light source and/or departure light source (e.g., cause the crossbar light source to generate a red light and/or cause the departure light source to generate light). In some embodiments, a vehicle sequence is dependent on a crossbar. For example, a controller may determine an accessory is inserted into an accessory insertion port of the crossbar and, in response, transmit a signal to a light source (e.g., cause a light source associated with the insertion port to generate a light). The controller may, in embodiments, cause a light source to perform more than one action in response to a vehicle sequence. For example, a controller determines that an auto-pilot system is about to slow the vehicle and cause the vehicle to make a turn and, in response to determining this vehicle sequence, the controller transmits a signal(s) that causes a crossbar light source to generate a red light and a crossbar light source to generate a yellow light and/or a departure light source to generate a light. In some embodiments, determining a vehicle sequence includes determining that all steps in the vehicle sequence have been performed. In other embodiments, determining a vehicle sequence includes determining less than all steps in the vehicle sequence have been performed. For example, determining a vehicle sequence may include determining that an initiation step for a vehicle sequence has been performed.

In some embodiments, the crossbars described herein (for example, crossbars 110, 120, 210, 220, and 310) are configured to support a load. As used herein, a crossbar is configured to support a load when the crossbar (alone or in combination with another crossbar) is rated to support 220 lbs. In some embodiments, the departure light source is integrated into the crossbar. In others, the departure light source is separate from the crossbar and is connected to the crossbar (or to the vehicle) as described further herein.

FIG. 7 illustrates an example vehicle 700. Vehicle 700 may include multiple sensors 710, multiple cameras 720, and a control system 730. In some embodiments, vehicle 700 may be able to pair with a computing device 750 (e.g., smartphone 750a, tablet computing device 750b, or a smart vehicle accessory). As an example and not by way of limitation, a sensor 710 may be an accelerometer, a gyroscope, a magnometer, a global positioning satellite (GPS) signal sensor, a vibration sensor (e.g., piezoelectric accelerometer), a light detection and ranging (LiDAR) sensor, a radio detection and ranging (RADAR) sensor, an ultrasonic sensor, a temperature sensor, a pressure sensor, a humidity sensor, a chemical sensor, an electromagnetic proximity sensor, an electric current sensor, another suitable sensor, or a combination thereof. As an example and not by way of limitation, a camera 720 may be a still image camera, a video camera, a 3D scanning system (e.g., based on modulated light, laser triangulation, laser pulse, structured light, light detection and ranging (LiDAR)), an infrared camera, another suitable camera, or a combination thereof. Vehicle 700 may include various controllable components (e.g., doors, seats, windows, lights, HVAC, entertainment system, security system), instrument and information displays and/or interactive interfaces, functionality to pair a computing device 750 with the vehicle (which may enable control of certain vehicle functions using the computing device 750), and functionality to pair accessories with the vehicle, which may then be controllable through an interactive interface in the vehicle or through a paired computing device 750.

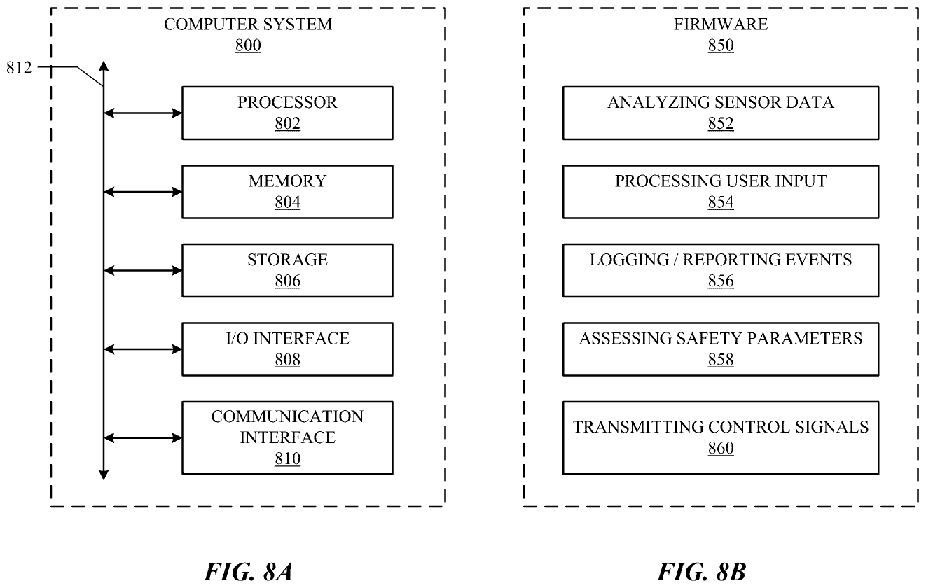

Control system 730 may enables control of various systems on-board the vehicle. As shown in FIG. 7, control system 730 may comprise one or more electronic control units (ECUs), each of which are dedicated to a specific set of functions. Each ECU may be a computer system (as described further in FIG. 8), and each ECU may include functionality provide by one or more of the example ECUs described below.

Features of embodiments as described herein may be controlled by a VDM ECU. The VDM ECU may control a number of different functions related to aspects of the vehicle's drivetrain, regenerative braking, suspension, steering, traction control, distribution of mass, aerodynamics, and driving modes. In some embodiments, the VDM ECU may, by way of example and not limitation, control vehicle acceleration, control vehicle energy regeneration, calculate torque distribution, provide traction control, control drive modes, provide odometer functions, control driveline disconnects, adjust damping, adjust roll stiffness, adjust ride height, automatically level a vehicle when on a slope, and control the emergency parking brake driver.

Features of embodiments as described herein may be controlled by a TCM ECU. The TCM ECU may provide a wireless vehicle communication gateway to support functionality such as, by way of example and not limitation, over-the-air (OTA) software updates, communication between the vehicle and the internet, communication between the vehicle and a computing device 750, in-vehicle navigation, vehicle-to-vehicle communication, communication between the vehicle and landscape features (e.g., automated toll road sensors, automated toll gates, power dispensers at charging stations), or automated calling functionality.

Features of embodiments as described herein may be controlled by a BCM ECU. The BCM ECU may provide electronic controls for various components of the body of the vehicle, such as, by way of example and not limitation: interior lighting (e.g., cabin lights, seatbelt lights), exterior lighting (e.g., headlamps, side lights, rear lights, camp lights), power outlets, frunk switch, window wiper movement and washer fluid deployment, the overhead center console, horn, power ports, and wireless accessory charging and docking.

Features of embodiments as described herein may be controlled by a CGM ECU. The CGM ECU may serve as the vehicle's communications hub that connects and transfer data to and from the various ECUs, sensors, cameras, motors, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes. In some embodiments, for electric vehicles, the CGM ECU may also control the vehicle charge port door and related light(s) and sensor(s).

Features of embodiments as described herein may be controlled by one or more ECUs may provide functions of an automated driving system (ADS) and/or an advanced driver assistance system (ADAS) that may be enabled by a driver of the vehicle to provide one or more functions to support driving assistance and/or automation. An Autonomy Control Module (ACM) ECU may process data captured by cameras 720 and/or sensors 710. In some embodiments, the ACM ECU may provide artificial intelligence functionality to provide and/or refine functions to support driving assistance and/or automation. An Autonomous Safety Module (ASM) ECU may provide functions to support driving safety by monitoring sensors that support self-driving functions. A Driver Monitoring System (DMS) ECU may provide functionality to monitor and inform the control system about the driver's level of attention (e.g., while relying on driving assistance and/or automation functions). The DMS may process data captured by a camera positioned to monitor the driver's gaze. A Park Assist Module (PAM) ECU may provide functions to assist a driver during manual and/or automated parking operations. The PAM ECU may process data captured by cameras 720 and/or sensors 710 in order to determine appropriate control commands.

Features of embodiments as described herein may be controlled by an XMM ECU may generate a user interface displayed on a dashboard of the vehicle. The user interface may display information and provide audio output for an infotainment system, including various views around and inside the vehicle. XMM may provide interactive controls for a number of different vehicle functions that may be controlled in conjunction with enabling the designated mode, such as, by way of example and not limitation: controlling interior and exterior lighting, vehicle displays (e.g., instrument cluster, center information display, and rear console display), audio output (e.g., audio processing, echo cancellation, beam focusing), music playback, heating, ventilation, and air conditioning (HVAC) controls, power settings, Wi-Fi connectivity, Bluetooth device connectivity, and vehicle leveling, as well as displaying information in the user interface (e.g., surround view camera feed, distance to nearest charger, and minimum range). In some embodiments, interactive controls provided by XMM may enable interaction with other modules of control system 730. In some embodiments, functions of the ACM and the XMM may be combined together into an Autonomous eXperience Module (AXM) ECU.

Vehicle 700 may include one or more additional ECUs, such as, by way of example and not limitation: a Vehicle Access System (VAS) ECU, a Near-Field Communication (NFC) ECU, a Seat Control Module (SCM) ECU, a Door Control Module (DCM) ECU, a Rear Zone Control (RZC) ECU, and/or a Winch Control Module (WCM) ECU. If vehicle 700 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU.

FIG. 8A illustrates an example computer system 800. Computer system 800 may include a processor 802, memory 804, storage 806, an input/output (I/O) interface 808, a communication interface 810, and a bus 812. Although this disclosure describes one example computer system including specified components in a particular arrangement, this disclosure contemplates any suitable computer system with any suitable number of any suitable components in any suitable arrangement. As an example and not by way of limitation, computer system 800 may be an ECU, an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, computer system 800 may include one or more computer systems 800; be unitary or distributed, span multiple locations, machines, or data centers; or reside in a cloud, which may include one or more cloud components in one or more networks. Where appropriate, computer system(s) 800 may perform, at different times or at different locations, in real time or in batch mode, one or more steps of one or more methods described or illustrated herein.

Processor 802 may include hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806 (e.g., storage units 824 and 834). Processor 802 may include one or more internal caches for data, instructions, or addresses.

In particular embodiments, memory 804 includes main memory for storing instructions for processor 802 to execute or data for processor 802 to operate on. In particular embodiments, one or more memory management units (MMUs) reside between processor 802 and memory 804 and facilitate accesses to memory 804 requested by processor 802. In particular embodiments, memory 804 includes random access memory (RAM). This disclosure contemplates any suitable RAM.

In particular embodiments, storage 806 includes mass storage for data or instructions. As an example and not by way of limitation, storage 806 may include a removable disk drive, flash memory, an optical disc, a magneto-optical disc, magnetic tape, or a Universal Serial Bus (USB) drive or two or more of these. Storage 806 may include removable or fixed media and may be internal or external to computer system 800. Storage 806 may include any suitable form of non-volatile, solid-state memory or read-only memory (ROM).

In particular embodiments, I/O interface 808 includes hardware, software, or both, providing one or more interfaces for communication between computer system 800 and one or more input and/or output (I/O) devices. Computer system 800 may be communicably connected to one or more of these I/O devices, which may be incorporated into, plugged into, paired with, or otherwise communicably connected to vehicle 700 (e.g., through the TCM ECU). An input device may include any suitable device for converting volitional user input into digital signals that can be processed by computer system 800, such as, by way of example and not limitation, a steering wheel, a touch screen, a microphone, a joystick, a scroll wheel, a button, a toggle, a switch, a dial, or a pedal. An input device may include one or more sensors for capturing different types of information, such as, by way of example and not limitation, sensors 710 described above. An output device may include devices designed to receive digital signals from computer system 800 and convert them to an output format, such as, by way of example and not limitation, speakers, headphones, a display screen, a heads-up display, a lamp, a smart vehicle accessory, another suitable output device, or a combination thereof. This disclosure contemplates any suitable I/O devices and any suitable I/O interfaces 808 for them. I/O interface 808 may include one or more I/O interfaces 808, where appropriate.

In particular embodiments, communication interface 810 includes hardware, software, or both providing one or more interfaces for data communication between computer system 800 and one or more other computer systems 800 or one or more networks. Communication interface 810 may include one or more interfaces to a controller area network (CAN) or to a local interconnect network (LIN). Communication interface 810 may include one or more of a serial peripheral interface (SPI) or an isolated serial peripheral interface (isoSPI). In some embodiments, communication interface 810 may include a network interface controller (NIC) or network adapter for communicating with an Ethernet or other wire-based network or a wireless NIC (WNIC) or wireless adapter for communicating with a wireless network, such as a WI-FI network or a cellular network.

In particular embodiments, bus 812 includes hardware, software, or both coupling components of computer system 800 to each other. Bus 812 may include any suitable bus, as well as one or more buses 812, where appropriate. Although this disclosure describes a particular bus, any suitable bus or interconnect is contemplated.

Herein, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 8B illustrates example firmware 850 for a vehicle ECU 800 as described with respect to control system 730. Firmware 850 may include functions 852 for analyzing sensor data based on signals received from sensors 710 or cameras 720 received through communication interface 810. Firmware 850 may include functions 854 for processing user input (e.g., directly provided by a driver of or passenger in vehicle 700, or provided through a computing device 750) received through I/O interface 808. Firmware 850 may include functions 856 for logging detected events (which may be stored in storage 806 or uploaded to the cloud), as well as functions for reporting detected events (e.g., to a driver or passenger of the vehicle through an instrument display or interactive interface of the vehicle, or to a vehicle manufacturer, service provider, or third party through communication interface 810). Firmware 850 may include functions 858 for assessing safety parameters (e.g., monitoring the temperature of a vehicle battery or the distance between vehicle 700 and nearby vehicles). Firmware 850 may include functions 860 for transmitting control signals to components of vehicle 700, including other vehicle ECUs 800.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. It should also be understood that as used in the description herein and throughout the claims that follow, the meaning of “a,” “an,” and “the” includes “one” and “more than one” unless the context clearly dictates otherwise.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. An apparatus, comprising:
a departure light source;
a crossbar comprising a light source; and
a controller configured to:
determine an orientation of a vehicle; and
in response to determining the orientation, cause the departure light source to generate a light.

2. The apparatus of claim 1, wherein the controller is further configured to: in response to determining the orientation, cause the crossbar light source to generate a light.

3. The apparatus of claim 1, wherein the crossbar light source generates light with a first center beam and the departure light source generates light with a second center beam, wherein the first center beam and the second center beam subtend an angle.

4. The apparatus of claim 1, wherein the departure light source generates light with a center beam that subtends an angle with a mounting plane of the crossbar.

5. The apparatus of claim 1, wherein the controller is configured to determine an orientation by:
determining the vehicle is travelling down an incline; and
determining the vehicle is approaching an end of the incline.

6. The apparatus of claim 1, wherein the controller is further configured to:
in response to determining the orientation, determine whether the vehicle meets an orientation lighting criteria;
in response to determining the vehicle meets the orientation lighting criteria, permit the departure light source to generate a light; and
in response to determining the vehicle does not meet the orientation lighting criteria, prevent the departure light source generating a light.

7. The apparatus of claim 1, wherein the controller is further configured to:
determine the orientation has ended; and
in response to determining the orientation has ended, cause the departure light source to stop generating the light.

8. The apparatus of claim 1, wherein the controller is further configured to:
determine a sequence of a vehicle; and
in response to determining the sequence, cause the crossbar light source to generate a light.

9. The apparatus of claim 8, wherein the controller is further configured to:
in response to determining the sequence, cause the departure light source to generate light in coordination with the crossbar light source generating a light.

10. The apparatus of claim 1, wherein the departure light source comprises an electrical connection.

11. The apparatus of claim 1, wherein the departure light source comprises a mount for coupling the departure light source to the crossbar.

12. The apparatus of claim 1, wherein the departure light source is integrated with the crossbar.

13. A vehicle comprising:
a headlamp light source that illuminates a first region in front of the vehicle;
a departure light source that illuminates a second region in front of the vehicle,
wherein the first region is closer to the vehicle than the second region; and
a control system comprising a processor and a memory comprising instructions executable by the processor, the processor operable to execute the instructions to perform operations comprising:
determine an orientation of the vehicle; and
in response to determining the orientation, causing the departure light source to illuminate the second region.

14. The vehicle of claim 13, wherein the headlamp light source generates light with a first center beam and the departure light source generates light with a second center beam, wherein the first center beam and the second center beam subtend an angle.

15. The vehicle of claim 13, further comprising a crossbar, wherein
the crossbar comprises a light source that illuminates a third region in front of the vehicle, wherein
the third region is positioned between the first and second regions.

16. The vehicle of claim 13, wherein the processor is operable to execute the instructions to perform operations further comprising:
determine the orientation has ended; and
in response to determining the orientation has ended, causing the departure light source to stop illuminating the second region.

17. A computer-readable non-transitory storage media embodying software comprising instructions operable when executed to perform operations comprising:
determine an orientation of a vehicle; and
in response to determining the orientation, causing a departure light source to generate a light.

18. The computer readable medium of claim 17, wherein the instructions are operable when executed to perform operations further comprising:
in response to determining the orientation, determine whether the vehicle meets an orientation lighting criteria;
in response to determining the vehicle meets the orientation lighting criteria, permit the departure light source to generate a light; and
in response to determining the vehicle does not meet the orientation lighting criteria, prevent the departure light source generating the light.

19. The computer readable medium of claim 17, wherein the instructions are operable when executed to perform operations further comprising:
determine the orientation has ended; and
in response to determining the orientation has ended, causing the departure light source to stop generating the light.

20. The computer readable medium of claim 17, wherein the instructions are operable when executed to perform operations further comprising:
determine a sequence of the vehicle; and
in response to determining the sequence, coordinate causing the departure light source to generate a light with causing the crossbar light to generate a light.
